(19) United States
(12) Patent Application Publication
(10) Pub. No.: US 2024/0412495 A1
(43) Pub. Date: Dec. 12, 2024

(54) DETERMINING COMMUNICATION CHANNEL BASED ON LIMITATION OF USER

(71) Applicant: Google LLC, Mountain View, CA (US)

(72) Inventors: Ruofei Du, San Francisco, CA (US); Xingyu Liu, Los Angeles, CA (US)

(21) Appl. No.: 18/736,910

(22) Filed: Jun. 7, 2024

Related U.S. Application Data
(60) Provisional application No. 63/507,264, filed on Jun. 9, 2023.

(51) Int. Cl. G06V 10/80; G06V 10/25; G06V 10/94; G06V 20/20; G06V 20/50

(52) U.S. Cl. CPC G06V 10/80; G06V 10/25; G06V 10/94; G06V 20/20; G06V 20/50

(57) ABSTRACT

A method comprises determining, by a head-mounted device, a limitation of a user based on a visual input received from a camera included in the head-mounted device; determining an output communication channel and an input communication channel based on the limitation of the user, sending a notification to the user via the output communication channel; and receiving an input from the user via the input communication channel.

### CROSS-REFERENCE TO RELATED APPLICATION

This application claims priority to U.S. Provisional Patent Application No. 63/507,264, filed on Jun. 9, 2023, the disclosure of which is incorporated by reference herein in its entirety.

### SUMMARY

A computing system, which can include a computing device such as a head-mounted device and/or a computing system in communication with the computing device, can determine a situational limitation of a user and a communication channel via which the computing device can communicate with the user while the user is experiencing the limitation. The limitation can be based on an activity of the user, such as hands of the user being occupied while the user is cooking, or a context or environment of the user, such as the user being at a loud concert where it is difficult to hear or speak into a microphone.

The computing device can determine an output communication channel and an input communication channel based on the limitation of the user. For example, if the hands of the user are occupied, the computing device can determine that the user could understand audio output and/or visual output and could provide voice input and/or gaze input. If the user is in a noisy environment, then the user could understand visual output and/or haptic output and could provide gaze input and/or tactile input. The computing device can send a notification to the user via the determined output communication channel. The computing device can receive and/or process an input from the user via the determined input communication channel.

According to an example, a method comprises determining, by a head-mounted device, a limitation of a user based on a visual input received from a camera included in the head-mounted device; determining an output communication channel and an input communication channel based on the limitation of the user; sending a notification to the user via the output communication channel; and receiving an input from the user via the input communication channel.

According to an example, a non-transitory computer-readable storage medium comprising instructions stored thereon. When executed by at least one processor, the instructions are configured to cause a computing system to determine a limitation of a user based on a visual input received from a camera included in a head-mounted device; determine an output communication channel and an input communication channel based on the limitation of the user; send a notification to the user via the output communication channel; and receive an input from the user via the input communication channel.

According to an example, a computing system comprises at least one processor and a non-transitory computer-readable storage medium comprising instructions stored thereon. When executed by the at least one processor, the instructions are configured to cause the computing system to determine a limitation of a user based on a visual input received from a camera included in a head-mounted device; determine an output communication channel and an input communication channel based on the limitation of the user; send a notification to the user via the output communication channel; and receive an input from the user via the input communication channel.

The details of one or more implementations are set forth in the accompanying drawings and the description below. Other features will be apparent from the description and drawings, and from the claims.

### BRIEF DESCRIPTION OF THE DRAWINGS

FIG. 1A shows a perspective of a user and augmented reality content presented by a head-mounted device worn by the user while the user is cooking.

FIG. 1B is a perspective view showing the user wearing the head-mounted device in the scene shown in FIG. 1A.

FIG. 2A shows an image captured by a head-mounted device with an egocentric view when a user wearing the head-mounted device is cooking.

FIG. 2B shows an image captured by a head-mounted device with an egocentric view when a user wearing the head-mounted device is attending a concert.

FIG. 2C shows an image captured by a head-mounted device with an egocentric view when a user wearing the head-mounted device is sitting at a desk with a workstation and taking notes on a tablet device.

FIG. 2D shows an image captured by a head-mounted device with an egocentric view when a user wearing the head-mounted device is showering a dog in a bathtub.

FIG. 2E shows an image captured by a head-mounted device with an egocentric view when a user wearing the head-mounted device is playing tennis at night on a lit tennis court.

FIG. 2F shows an image captured by a head-mounted device with an egocentric view when a user wearing the head-mounted device is riding on a bus.

FIG. 2G shows an image captured by a head-mounted device with an egocentric view when a user wearing the head-mounted device is in a kitchen washing dishes.

FIG. 2H shows an image captured by a head-mounted device with an egocentric view when a user wearing the head-mounted device is playing a video game on a computer.

FIG. 3 shows a pipeline for determining a channel via which to communicate with a user based on input received by a computing system.

FIG. 4 shows a prompt structure for determining a channel via which to communicate based on a language model.

FIG. 5 shows a decision tree for determining availability of a channel for communicating with a user.

FIG. 6 is a block diagram of a computing system.

FIGS. 7A, 7B, and 7C show an example of the head-mounted device.

FIG. 8 is a flowchart showing a method performed by a computing system.

Like reference numbers refer to like elements.

### DETAILED DESCRIPTION

A computing device and/or mobile device such as a head-mounted device can provide output such as notifications to a user and receive input from the user. The mobile device can provide the output by graphical output, audio output, or haptic feedback, as non-limiting examples. The mobile device can receive the input by tactile input, gaze input, gesture input, or voice input, as non-limiting examples.

A technical problem with providing output to a user and receiving input from the user is that current limitations can impede some channels of communication between the mobile device and the user. The limitations can be based on a present situation of a user and include activities of the user, which prevent the user from accessing some channels of communication, and/or the context or environment of the user, which prevent the user from accessing some channels of communication. The limitations can be caused by various situational factors, such as noise or lighting.

A technical solution to the technical problem of limitations impeding some channels of communication is to determine any current limitations and, based on the current limitations, determine a communication channel(s) via which to send output to the user and/or receive input from the user. The mobile device can thereafter send output to the user via a determined output communication channel and receive input from the user via a determined input communication channel. A technical benefit of this technical solution is accurate and efficient transmission of information between the mobile device and the user. A further technical benefit of determining communication channels based on limitations of channels of communication is applicability to a wide range of scenarios, obviating a need to map communication channels to particular scenarios. A further technical benefit is that when a computing system mis-describes an activity (such as describing scrubbing wood with sandpaper as climbing a wooden ladder), the computing system can still provide accurate channel predictions due to similarities in hand occupancy and/or environmental volume level.

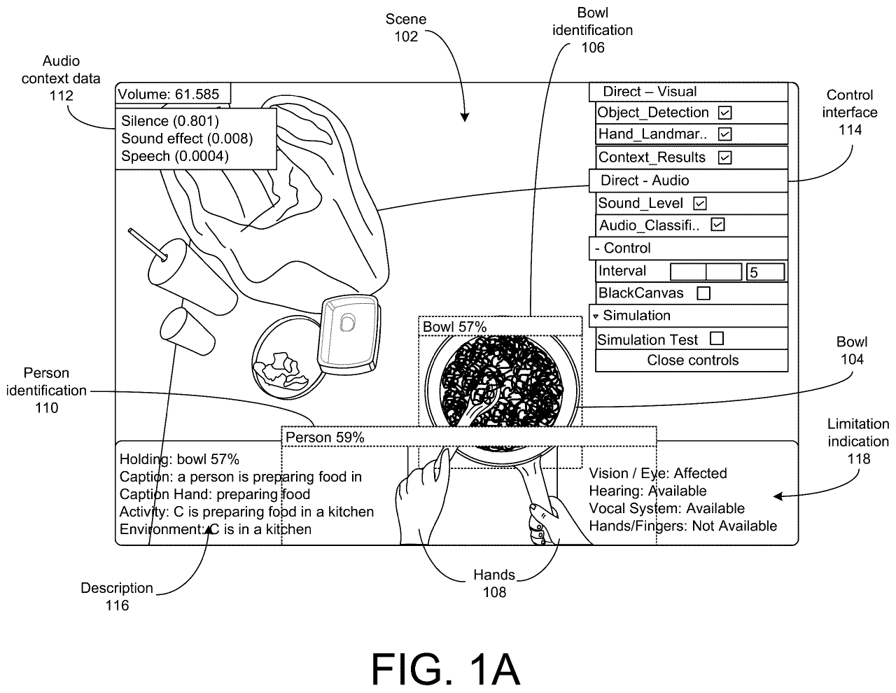

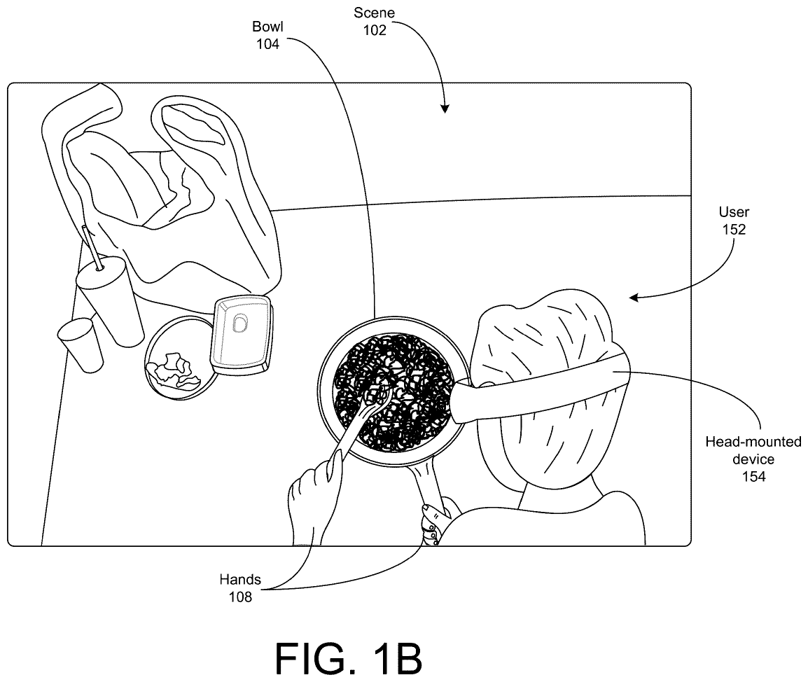

FIG. 1A shows a perspective of a user 152 and augmented reality content presented by a head-mounted device 154 worn by the user while the user 152 is cooking. FIG. 1B is a perspective view showing the user 152 wearing the head-mounted device 154 in the scene 102 shown in FIG. 1A. As in FIG. 1A, hands 108 of the user 152 are occupied cooking a bowl 104 of food.

The user 152 can interact with physical objects within a scene 102. The scene 102 can include physical objects that exist independently of augmented reality content. The user 152 can view the scene 102 through transparent lenses included in the head-mounted device 154. The head-mounted device 154 can include glasses such as smartglasses that include transparent lenses through which the user 152 can view the scene 102. The head-mounted device 154 can project augmented reality content onto the lenses for the user 152 to view.

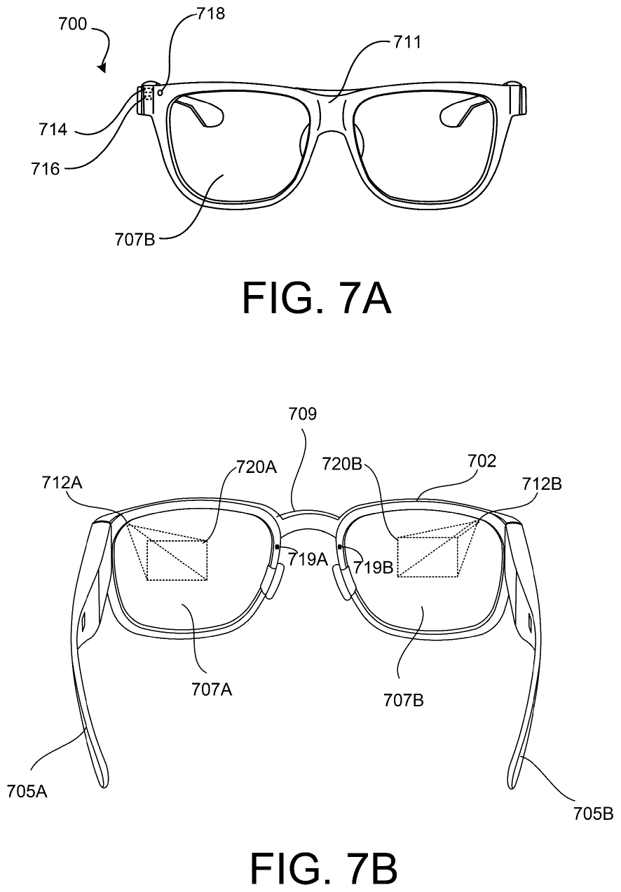

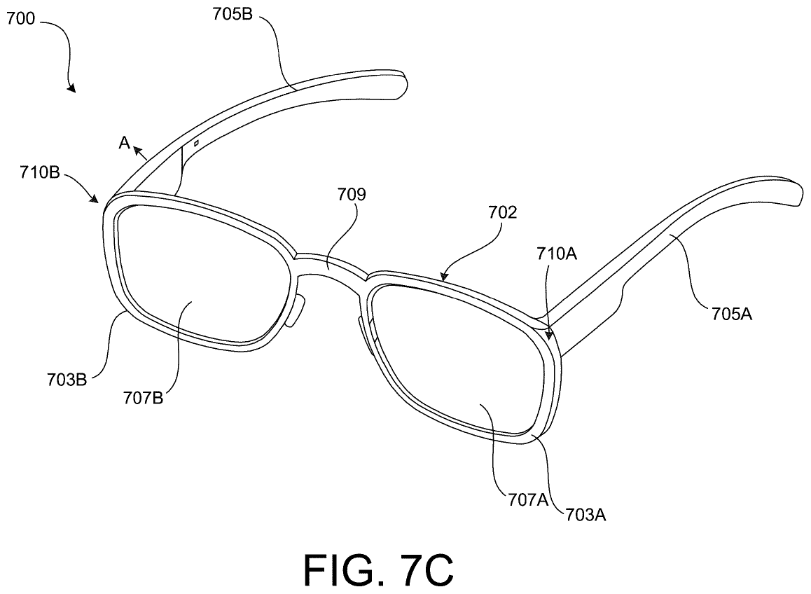

The head-mounted device 154 can include one or more speakers to provide audio output to the user 152. The head-mounted device 154 can include one or more buttons or surfaces to receive tactile and/or touch input from the user 152. The head-mounted device 154 can include one or more microphones to receive voice input from the user 152 and/or audio input from the environment in which the user 152 is present. The head-mounted device 154 can include one or more cameras to capture the scene 102 from a perspective of the user 152 (which can be considered an “egocentric” perspective). The head-mounted device 154 can include one or more gaze-tracking cameras that can capture images of one or more eyes of the user 152 to determine a direction of gaze of the user 152 and/or a physical or virtual object at which the user 152 is gazing. The head-mounted device 154 is shown and described in more detail with respect to FIGS. 7A, 7B, and 7C.

The head-mounted device 154 can identify objects included in the scene 102 based on images captured by one or more cameras. In the example shown in FIG. 1A, the head-mounted device 154 identifies a bowl 104 (or pot) of soup that the user 152 is cooking (or heating) on the stove. The head-mounted device 154 presents a bowl identification 106 as augmented reality content to the user 152. The bowl identification 106 can include a graphical indicator such as a box around the identified object (e.g. the bowl 104). The bowl identification 106 can include a textual identifier and/or description of the identified object (such as “bowl”). The bowl identification 106 can include a confidence value indicating a level of confidence that the head-mounted device 154 has that the identification of the object is correct (such as 57% in the example of the bowl identification 106). The bowl identification 106 is an example of augmented reality content generated by the head-mounted device 154.

In the example of FIG. 1A, the head-mounted device 154 identifies hands 108 of the user 152 as being portions (or body parts) of a person. The identification of the hands 108 of the user 152 as being portions of a person is indicated by the person identification 110. The person identification 110 can include a graphical indicator such as a box around the identified object(s) (e.g. the hands 108). The person identification 110 can include a textual identifier and/or description of the identified object (such as “person”). The person identification 110 can include a confidence value indicating a level of confidence that the head-mounted device 154 has that the identification of the object is correct (such as 59% in the example of the person identification 110). The person identification 110 is an example of augmented reality content generated by the head-mounted device 154.

In the example of FIG. 1A, the head-mounted device 154 presents audio context data 112. The audio context data 112 is an example of augmented reality content generated by the head-mounted device 154. The context data can include a volume of sound (or noise) captured by one or more microphones included in the head-mounted device 154, a proportion of silence detected by the one or more microphones, a proportion of sound effects detected by the one or more microphones, and/or a proportion of speech detected by the one or more microphones.

In the example of FIG. 1A, the head-mounted device 154 presents a control interface 114. The control interface 114 is an example of augmented reality content generated by the head-mounted device 154. The control interface 114 enables the user 152 to turn features, such as object detection, hand landmark detection, context results, a sound level, audio classification, intervals, a black canvas, and/or simulation tests, on or off. In some examples, the user 152 turns features presented by the control interface 114 on or off by gesture input detected by a front-facing camera included in the head-mounted device 154. In some examples, the user 152 turns features presented by the control interface 114 on or off by gaze input detected by a gaze-tracking camera included in the head-mounted device 154.

In the example of FIG. 1A, the head-mounted device 154 presents a description 116 of the scene 102. In some examples, the description 116 is text generated by a model, such as a large language model, based on one or more images of the scene 102 captured by one or more cameras included in the head-mounted device 154. In the example shown in FIG. 1A, the description 116 includes text, “Holding: bowl 57% [describing an activity and confidence level of the description]; Caption: a person is preparing food in [a kitchen] [description of scene 102]; Caption Hand: preparing food [description of activity of hands 108]; Activity: C is preparing food in a kitchen [description of scene 102 with reference to name of user 152 ‘C’]; Environment: C is in a kitchen [description of environment with reference to name of user 152 C].”

In the example of FIG. 1A, the head-mounted device 154 presents a limitation indication 118. The limitation indication 118 indicates limitations on channels for the user 152 to communicate with the head-mounted device 154. In some examples, the limitations are based on the description 116 generated by the model. In some examples, the limitations are based on the image(s) of the scene 102 captured by the camera(s) included in the head-mounted device 154.

In some examples, the limitation indication 118 indicates availability of vision of the user 152 to receive visual output from the head-mounted device 154 and/or eyes for gaze input captured by one or more cameras of the head-mounted device 154. In some examples, the limitation indication 118 indicates availability of hearing of the user 152 to receive audio output from the head-mounted device 154. In some examples, the limitation indication 118 indicates availability of a vocal system of the user 152 to provide audio input to the head-mounted device 154. In some examples, the limitation indication 118 indicates availability of hands and/or fingers to provide tactile input to the head-mounted device 154 and/or receive haptic feedback from the head-mounted device 154.

In the example shown in FIG. 1A, the limitation indication 118 indicates that vision and/or eyes are affected by a need of the user 152 to look at and/or focus on the bowl 104. In the example shown in FIG. 1A, the limitation indication 118 indicates that hearing is available for the user 152 to receive audio output because cooking does not interfere with an ability of the user 152 to hear audio output from the head-mounted device 154. In the example shown in FIG. 1A, the limitation indication 118 indicates that a vocal system is available because cooking does not interfere with an ability of the user 152 to speak and/or provide vocal input to the head-mounted device 154. In the example shown in FIG. 1A, the limitation indication 118 indicates that hands and/or fingers are not available for input or output to or from the head-mounted device 154 because the hands and/or fingers of the user 152 are needed for cooking. In some examples, the head-mounted device 154 determines the limitations heuristically based on determinations of activities of the user 152. In some examples, the head-mounted device 154 determines the limitations statistically based on previous determinations of activities of the user 152 and success at communicating with the user 152 via different channels.

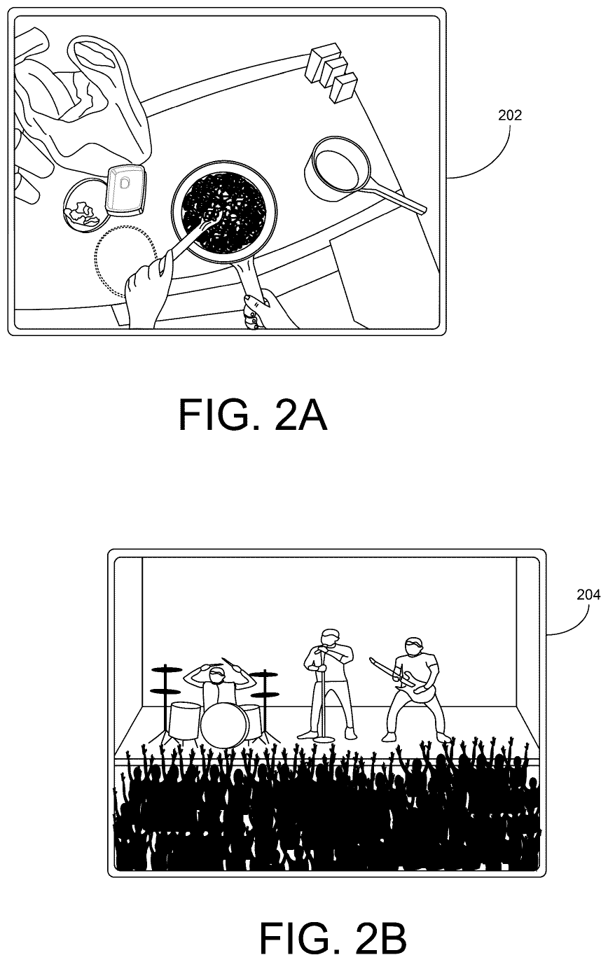

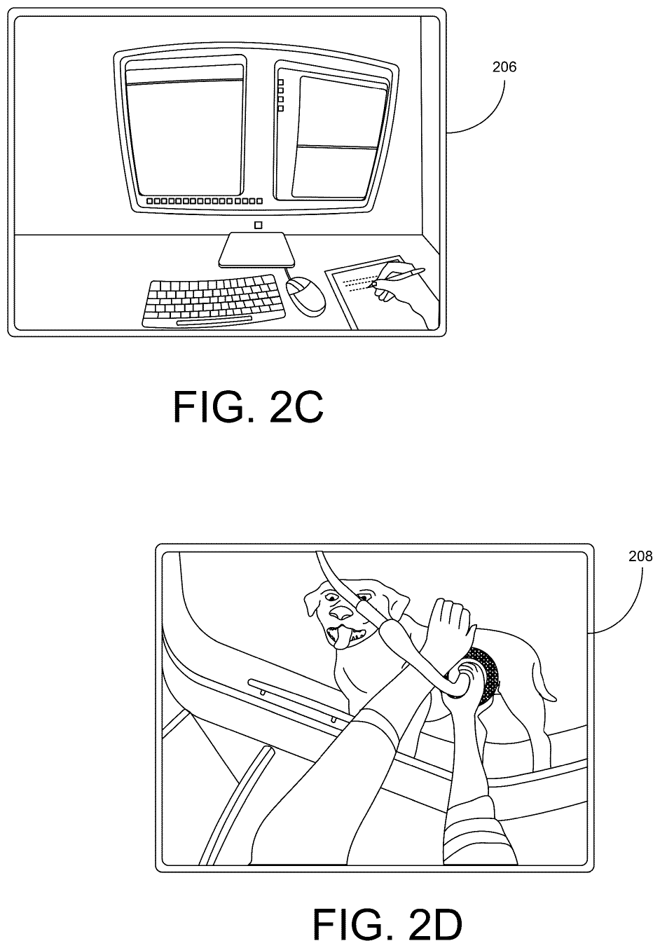

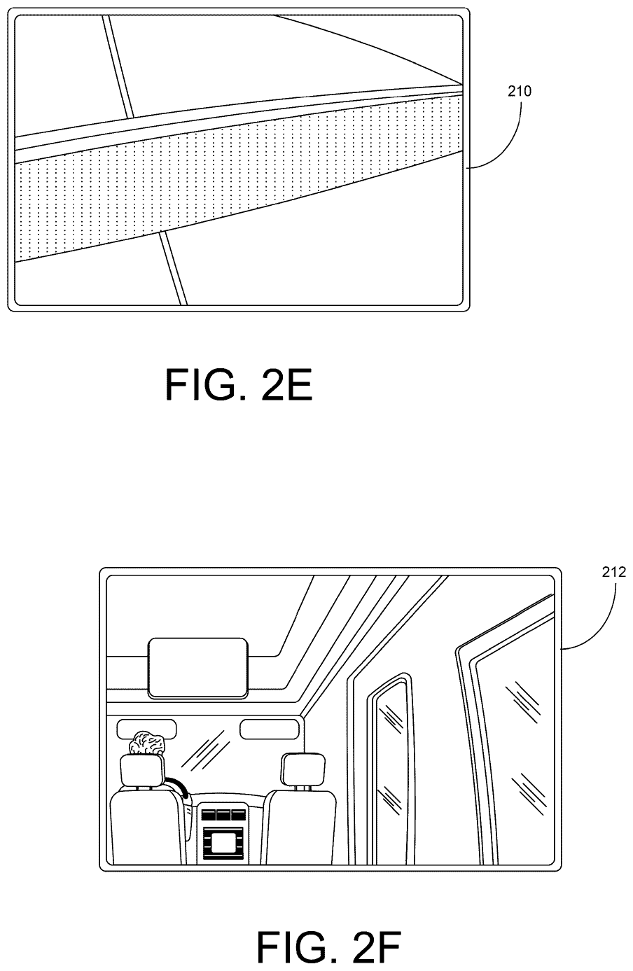

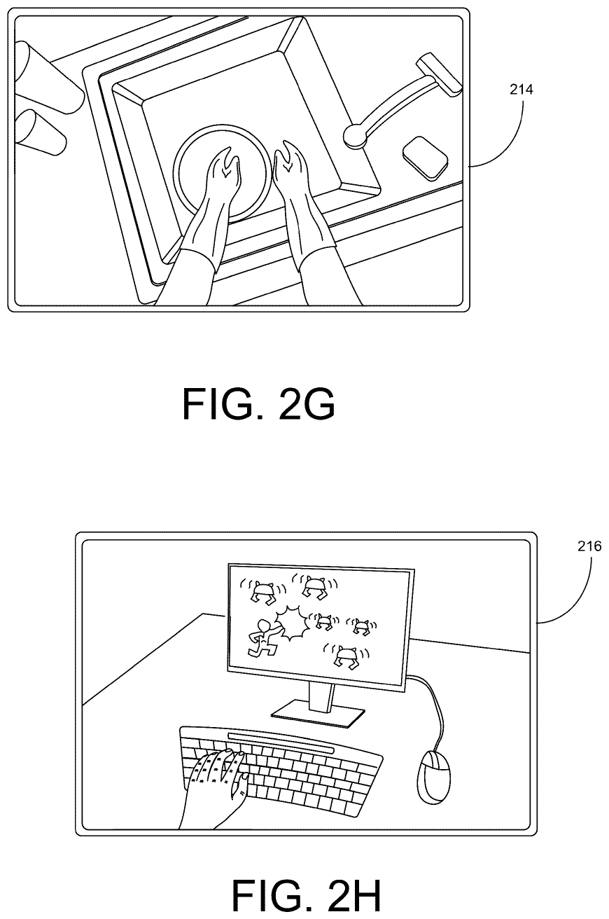

FIGS. 2A through 2H show images captured by a head-mounted device with egocentric views when a user is wearing the head-mounted device. In some examples, the head-mounted device is the same head-mounted device 154 as described above and the user is the same user 152 as described above. Based on the egocentric view and/or audio captured by the head-mounted device, the head-mounted device can determine a context and/or activity. The context and/or activity can include an activity, an environment, a hand task, and/or a noise volume. Based on the context and/or activity, the head-mounted device can determine one or more limitations of the user. The limitations can be determined with respect to vision and/or eyes of the user, hearing of the user, a vocal system of the user, and/or hands and/or fingers of the user. Based on the one or more limitations of the user, the head-mounted device can determine an output communication channel to send notifications (and/or output) to the user and/or an input communication channel to receive input from the user.

An output communication channel based on vision can include presenting a text message or a video. An output communication channel based on hearing can include audible outputs or notifications or voice output during a telephone conversation. An output communication channel based on tactile output can include haptic feedback or temperature output. An output communication channel based on taste can include the user drinking and/or eating. An output communication channel based on smell can include the user smelling.

An input communication channel based on eyes and/or gaze can include facial identification and/or gaze-based interaction. An input communication channel based on a vocal system can include a conversation, voice commands, and/or voice assistants. An input communication channel based on hands and/or fingers can include input via a touchscreen and/or gesture control. An input communication channel based on limbs and/or movement can include processing input by determining that the user is walking and/or reaching. An input communication channel based on a head and/or face of the user can include processing input based on determining that the user is nodding and/or making a facial expression.

FIG. 2A shows an image 202 captured by a head-mounted device with an egocentric view when a user wearing the head-mounted device is cooking. Based on the egocentric view and/or audio captured by the head-mounted device, the head-mounted device can determine that an activity is a user preparing food in a kitchen. Based on the egocentric view and/or audio captured by the head-mounted device, the head-mounted device can determine that an environment is the user being in a kitchen. Based on the egocentric view and/or audio captured by the head-mounted device, the head-mounted device can determine that a hand of the user is holding a bowl. Based on the egocentric view and/or audio captured by the head-mounted device, the head-mounted device can determine that a volume of noise is 65 decibels.

Based on the context and/or activity, the head-mounted device can determine that a limitation of vision and/or eyes of the user is slightly affected because the user is focusing viewing on an object (the bowl and/or food) outside the head-mounted device. Based on the context and/or activity, the head-mounted device can determine that a limitation of hearing of the user is available. Based on the context and/or activity, the head-mounted device can determine that a limitation of a vocal system of the user is available. Based on the context and/or activity, the head-mounted device can determine that a limitation of hands and/or fingers of the user is affected because the user will have difficulty providing gesture input due to the activity (cooking) occupying hands of the user. Based on the determined limitations indicating that hearing is available and a vocal system is available, the head-mounted device can send output and/or notifications to the user via sound and/or audible output and receive spoken commands (vocal system) as input from the user.

FIG. 2B shows an image 204 captured by a head-mounted device with an egocentric view when a user wearing the head-mounted device is attending a concert. Based on the egocentric view and/or audio captured by the head-mounted device, the head-mounted device can determine that that an activity is a user attending an outdoor concert. Based on the egocentric view and/or audio captured by the head-mounted device, the head-mounted device can determine that an environment is the user being at an outdoor event. Based on the egocentric view and/or audio captured by the head-mounted device, the head-mounted device can determine that a hand of the user is not affected. Based on the egocentric view and/or audio captured by a microphone included in the head-mounted device, the head-mounted device can determine that a volume of noise is 112 decibels.

Based on the context and/or activity, the head-mounted device can determine that a limitation of vision and/or eyes of the user is slightly affected because the user is focusing viewing on an object (the stage or band members) outside the head-mounted device. Based on the context and/or activity, the head-mounted device can determine that a limitation of hearing of the user is unavailable because the user will have difficulty understanding audio output because noise from the concert will interfere with audio output of the head-mounted device. The head-mounted device can determine that the noise from the concert will interfere with the audio output based on the volume of noise (e.g. 112 decibels) satisfying a noise threshold. Based on the context and/or activity, the head-mounted device can determine that a limitation of a vocal system of the user is unavailable because the head-mounted device will have difficulty receiving and/or processing audio input generated by a voice of the user because noise from the concert will interfere with the voice input. The head-mounted device can determine that the noise from the concert will interfere with the voice input based on the volume of noise (e.g. 112 decibels) satisfying a noise threshold. Based on the context and/or activity, the head-mounted device can determine that a limitation of hands and/or fingers of the user is available. Based on the determined limitations indicating that hands and/or fingers are available, the head-mounted device can send output and/or notifications to the user via haptic feedback (such as vibrations) and receive tactile input from the user.

FIG. 2C shows an image 206 captured by a head-mounted device with an egocentric view when a user wearing the head-mounted device is sitting at a desk with a workstation and taking notes on a tablet device. Based on the egocentric view and/or audio captured by the head-mounted device, the head-mounted device can determine that that an activity is a user taking notes on a tablet device. Based on the egocentric view and/or audio captured by the head-mounted device, the head-mounted device can determine that an environment is the user being in an office. Based on the egocentric view and/or audio captured by the head-mounted device, the head-mounted device can determine that a hand of the user is taking notes. Based on the egocentric view and/or audio captured by the head-mounted device, the head-mounted device can determine that a volume of noise is 42 decibels.

Based on the context and/or activity, the head-mounted device can determine that a limitation of vision and/or eyes of the user is affected because the user will have difficulty viewing an object presented on a display of the head-mounted device. The user may have difficulty viewing an object presented on the display because the user is focusing viewing on an object (the workstation or tablet device) outside the head-mounted device. Based on the context and/or activity, the head-mounted device can determine that a limitation of hearing of the user is available. Based on the context and/or activity, the head-mounted device can determine that a limitation of a vocal system of the user is available. Based on the context and/or activity, the head-mounted device can determine that a limitation of hands and/or fingers of the user is affected because the user will have difficulty providing gesture input based on the activity of typing and/or taking notes occupying hands of the user. Based on the determined limitations indicating that hearing is available and a vocal system is available, the head-mounted device can send output and/or notifications to the user via sound and/or audible output and receive spoken commands (vocal system) as input from the user.

FIG. 2D shows an image 208 captured by a head-mounted device with an egocentric view when a user wearing the head-mounted device is showering a dog in a bathtub. Based on the egocentric view and/or audio captured by the head-mounted device, the head-mounted device can determine that that an activity is a user showering a dog in a bathtub. Based on the egocentric view and/or audio captured by the head-mounted device, the head-mounted device can determine that an environment is the user being in a bathroom. Based on the egocentric view and/or audio captured by the head-mounted device, the head-mounted device can determine that a hand of the user is showering a dog. Based on the egocentric view and/or audio captured by the head-mounted device, the head-mounted device can determine that a volume of noise is 58 decibels.

Based on the context and/or activity, the head-mounted device can determine that a limitation of vision and/or eyes of the user is affected because the user will have difficulty viewing an object presented on a display of the head-mounted device based on the user focusing viewing on an object (the dog) outside of the head-mounted device. Based on the context and/or activity, the head-mounted device can determine that a limitation of hearing of the user is available. Based on the context and/or activity, the head-mounted device can determine that a limitation of a vocal system of the user is available. Based on the context and/or activity, the head-mounted device can determine that a limitation of hands and/or fingers of the user is unavailable because the user will have difficulty providing gesture input based on an activity (showering the dog) occupying hands of the user. Based on the determined limitations indicating that hearing is available and a vocal system is available, the head-mounted device can send output and/or notifications to the user via sound and/or audible output and receive spoken commands (vocal system) as input from the user.

FIG. 2E shows an image 210 captured by a head-mounted device with an egocentric view when a user wearing the head-mounted device is playing tennis at night on a lit tennis court. Based on the egocentric view and/or audio captured by the head-mounted device, the head-mounted device can determine that that an activity is a user playing tennis. Based on the egocentric view and/or audio captured by the head-mounted device, the head-mounted device can determine that an environment is the user being at a tennis court. Based on the egocentric view and/or audio captured by the head-mounted device, the head-mounted device can determine that a hand of the user is holding a tennis racket. Based on the egocentric view and/or audio captured by the head-mounted device, the head-mounted device can determine that a volume of noise is 35 decibels.

Based on the context and/or activity, the head-mounted device can determine that a limitation of vision and/or eyes of the user is affected because the user will have difficulty viewing an object presented on a display of the head-mounted device based on the user focusing on an object (a tennis ball) outside the head-mounted device. Based on the context and/or activity, the head-mounted device can determine that a limitation of hearing of the user is available. Based on the context and/or activity, the head-mounted device can determine that a limitation of a vocal system of the user is available. Based on the context and/or activity, the head-mounted device can determine that a limitation of hands and/or fingers of the user is affected because the user will have difficulty providing gesture input based on the activity (holding and swinging a tennis racket) occupying hands of the user. Based on the determined limitations indicating that hearing is available and a vocal system is available, the head-mounted device can send output and/or notifications to the user via sound and/or audible output and receive spoken commands (vocal system) as input from the user.

FIG. 2F shows an image 212 captured by a head-mounted device with an egocentric view when a user wearing the head-mounted device is riding on a bus. Based on the egocentric view and/or audio captured by the head-mounted device, the head-mounted device can determine that that an activity is a user sitting on a seat of a bus. Based on the egocentric view and/or audio captured by the head-mounted device, the head-mounted device can determine that an environment is the user being on a public bus. Based on the egocentric view and/or audio captured by the head-mounted device, the head-mounted device can determine that a hand of the user is unoccupied. Based on the egocentric view and/or audio captured by the head-mounted device, the head-mounted device can determine that a volume of noise is 55 decibels.

Based on the context and/or activity, the head-mounted device can determine that a limitation of vision and/or eyes of the user is available. Based on the context and/or activity, the head-mounted device can determine that a limitation of hearing of the user is slightly affected based on noise on the bus interfering with audio output. Based on the context and/or activity, the head-mounted device can determine that a limitation of a vocal system of the user is affected because the head-mounted device will have difficulty receiving and/or processing audio input generated by a voice of the user based on the noise on the bus interfering with the audio input. Based on the context and/or activity, the head-mounted device can determine that a limitation of hands and/or fingers of the user is available. Based on the determined limitations indicating that vision and/or eyes are available and hands and/or fingers are available, the head-mounted device can send output and/or notifications to the user via a display and receive touch or tactile input from the user.

FIG. 2G shows an image 214 captured by a head-mounted device with an egocentric view when a user wearing the head-mounted device is in a kitchen washing dishes in a sink. Based on the egocentric view and/or audio captured by the head-mounted device, the head-mounted device can determine that that an activity is a user washing dishes in a sink. Based on the egocentric view and/or audio captured by the head-mounted device, the head-mounted device can determine that an environment is the user being in a kitchen. Based on the egocentric view and/or audio captured by the head-mounted device, the head-mounted device can determine that a hand of the user is washing dishes. Based on the egocentric view and/or audio captured by the head-mounted device, the head-mounted device can determine that a volume of noise is 60 decibels.

Based on the context and/or activity, the head-mounted device can determine that a limitation of vision and/or eyes of the user is slightly affected based on the user focusing viewing on an object (one or more dishes) outside the head-mounted device. Based on the context and/or activity, the head-mounted device can determine that a limitation of hearing of the user is available. Based on the context and/or activity, the head-mounted device can determine that a limitation of a vocal system of the user is available. Based on the context and/or activity, the head-mounted device can determine that a limitation of hands and/or fingers of the user is affected because the user will have difficulty providing gesture input based on the activity (washing dishes) occupying hands of the user. Based on the determined limitations indicating that hearing is available and a vocal system is available, the head-mounted device can send output and/or notifications to the user via sound and/or audible output and receive spoken commands (vocal system) as input from the user.

FIG. 2H shows an image captured by a head-mounted device with an egocentric view when a user wearing the head-mounted device is playing a video game on a computer. Based on the egocentric view and/or audio captured by the head-mounted device, the head-mounted device can determine that that an activity is a user playing a video game. Based on the egocentric view and/or audio captured by the head-mounted device, the head-mounted device can determine that an environment is the user being in a living room. Based on the egocentric view and/or audio captured by the head-mounted device, the head-mounted device can determine that a hand of the user is interacting with a keyboard. Based on the egocentric view and/or audio captured by the head-mounted device, the head-mounted device can determine that a volume of noise is 35 decibels.

Based on the context and/or activity, the head-mounted device can determine that a limitation of vision and/or eyes of the user is affected because the user will have difficulty viewing an object presented on a display of the head-mounted device based on the user focusing viewing on the video game. Based on the context and/or activity, the head-mounted device can determine that a limitation of hearing of the user is available. Based on the context and/or activity, the head-mounted device can determine that a limitation of a vocal system of the user is available. Based on the context and/or activity, the head-mounted device can determine that a limitation of hands and/or fingers of the user is affected because the user will have difficulty providing gesture input based on the activity (playing the video game and manipulating a controller) occupying hands of the user. Based on the determined limitations indicating that hearing is available and a vocal system is available, the head-mounted device can send output and/or notifications to the user via sound and/or audible output and receive spoken commands (vocal system) as input from the user.

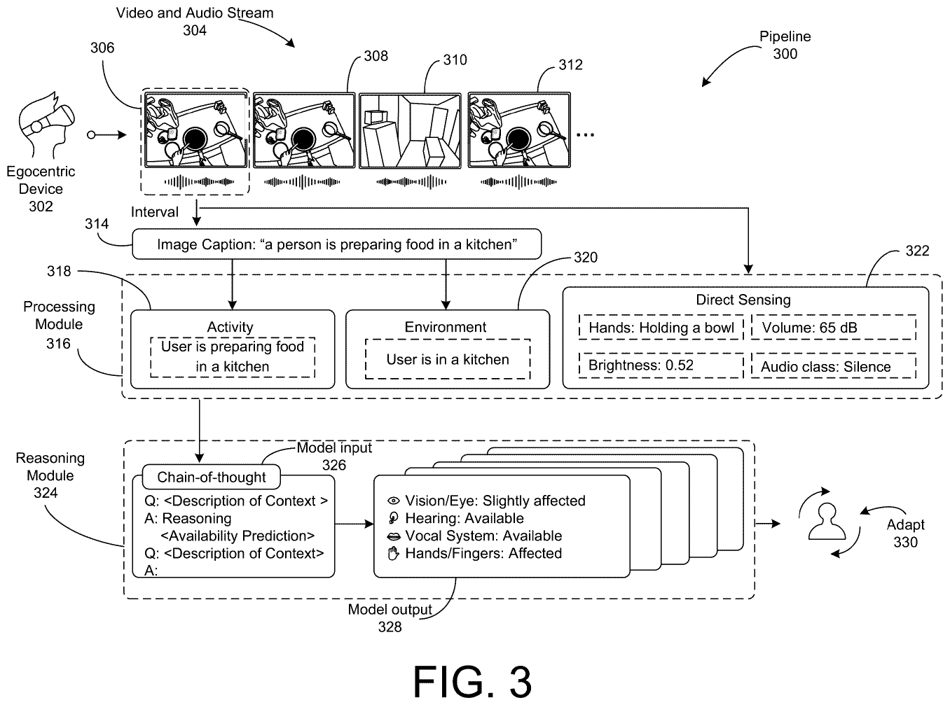

FIG. 3 shows a pipeline 300 for determining a channel via which to communicate with a user based on input received by a computing system. The pipeline 300 can include an egocentric device 302 device that captures input, such as video input and/or audio input, from a perspective of a user. The egocentric device 302 can include, for example, a head-mounted device such as the head-mounted device 154 shown and described above. The egocentric device 302 can include, for example, an augmented reality headset.

The egocentric device 302 can capture a video and audio stream 304. The video and audio stream 304 can include images captured from a direction away from the user, so that the images are similar to the scene as viewed by the user. In some examples, the images being captured from the direction away from the user cause the images to exclude any portion of a face and/or head of the user. In some examples, the images being captured from the direction away from the user cause the images to exclude any portion of a face, head, and/or torso of the user. The video and audio stream 304 can include multiple video frames and associated audio streams 306, 308, 310, 312. The multiple video frames and associated audio streams 306, 308, 310, 312 can be captured by the egocentric device 302 and be associated with successive time periods. In some examples, the video frames and associated audio streams 306, 308, 310, 312 each capture a time interval of, for example, one second of video data and concurrent audio data. The video and audio stream 304 and/or video frame and associated audio stream 306 corresponds to the image(s) and associated audio stream shown and described with respect to FIG. 1A.

For each interval, a processing module 316 included in a computing system such as the egocentric device 302 and/or a computing device in communication with the egocentric device 302 can generate an image caption 314. A model, such as a large language model, implemented and/or accessed by the processing module 316, can determine and/or generate the image caption 314, activity 318, and/or environment 320. The image caption 514 can have similar features to the description 116 described above with respect to FIG. 1A and/or the determined activity and/or environment described above with respect to FIGS. 2A through 2H. In the example shown in FIG. 3, the image caption 314 is determined to be, “a person is preparing food in a kitchen.” The image caption 314 can be divided into an activity 318 and an environment 320. In the example shown in FIG. 3, the activity 318 is, “User is preparing food in a kitchen.” In the example shown in FIG. 3, the environment 320 is, “User is in a kitchen.”

The processing module 316 can perform direct sensing 322 to determine values of, and/or generate a description of, an environment associated with the interval of the video frame and associated audio stream 306. In the example of FIG. 3, the direct sensing 322 indicates that hands of the user are, “Holding a bowl,” a brightness of light is 0.52, a volume of noise is 65 decibels, and an audio class is, “Silence.”

Based on the activity 318, environment 320, and/or direct sensing 322 determined and/or generated by the processing module 316, a reasoning module 324 included in the computing system can determine availability of communication channels. A model input 326 included in the reasoning module 324 can generate a chain-of-thought. The chain-of-thought can include prompts (such as questions requesting a description of a context of the video frame and associated audio stream) and associated answers predicting availability of communication channels. Chain-of-thought can generate prompts for intermediate natural language reasoning to arrive at a final output. The communication channels can include vision and/or eye, hearing, vocal system, and/or hands and/or fingers.

A model output 328 included in the reasoning module 324 can predict availability of communication channels based on the model input 326. The model output 328 can include channel indications based on the chain-of-thought of the model input 326. In the example shown in FIG. 3, the model output 328 for the video frame and associated audio stream 306 in which the user is holding a bowl and preparing food in a kitchen includes vision and/or eye being slightly affected, hearing being available, vocal system being available, and/or fingers and/or hands being affected. The computing system can thereafter adapt 330 communication channels based on the channel indications of the model output 328, such as sending audio notifications based on hearing being available and receiving voice input based on the vocal system being available.

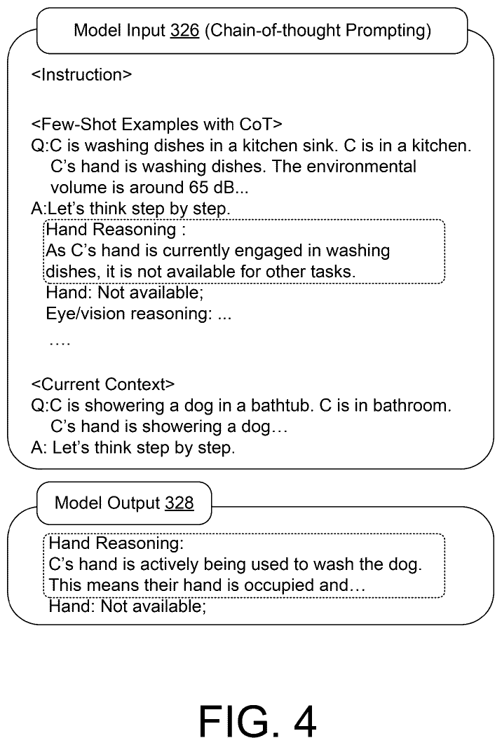

FIG. 4 shows a prompt structure for determining a channel via which to communicate based on a language model. The prompt structure and determination of the channel can be implemented by the model input 326 and model output 328 included in the reasoning module 324 shown in FIG. 3. The model input 326 can include, within a chain-of-thought, a question that includes a description of the activity of the user and a context of the user. The model input 326 can include, within the chain-of-thought, an answer that includes a description of availabilities of communication channels.

The model output 328 can include indications of availability of communication channels and reasoning for the availability or unavailability of the communication channels. The reasoning and indications of availability can be based on language models such as large language models.

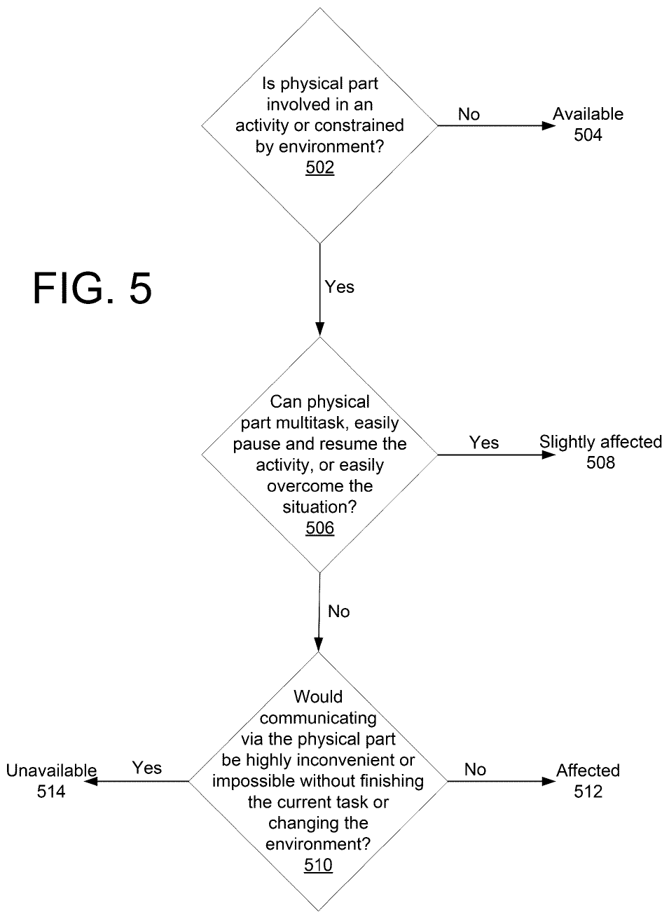

FIG. 5 shows a decision tree for determining availability of a channel for communicating with a user. The decision tree can represent a flowchart and/or method performed by a computing system such as the head-mounted device 154 or a computing device in communication with the head-mounted device 154. The decision tree can represent decisions made by the computing system with respect to a physical part (or system) of the user. As used herein, a physical part (or system) may include a body part, limb, or appendage, such as an eye or vision of the user, an car of the user, a joint or limb of the user, a nose of the user, a hand of the user, and/or a vocal system of the user.

The computing system can determine whether the physical part of the user is involved in an activity or is constrained by the environment (502). If the physical part of the user is not involved with an activity or constrained by the environment, then the computing system can determine that the physical part of the user is available (504).

If the physical part of the user is involved in an activity or is constrained by the environment, then the computing system can determine whether the physical part of the user can multitask, easily pause or resume activity, or easily overcome the situation (506). If the physical part of the user can multitask, easily pause or resume activity, or easily overcome the situation, then the computing system determines that the physical part of the user is slightly affected (508).

If the physical part of the user cannot multitask, easily pause or resume activity, or easily overcome the situation, then the computing system determines whether communicating via the physical part of the user would be highly inconvenient or impossible without finishing the current task or changing the environment (510). If communicating via the physical part of the user would not be highly inconvenient or impossible without finishing the current task or changing the environment, then the physical part of the user is affected (512). If communicating via the physical part of the user would be highly inconvenient or impossible without finishing the current task or changing the environment, then the physical part of the user is unavailable (514).

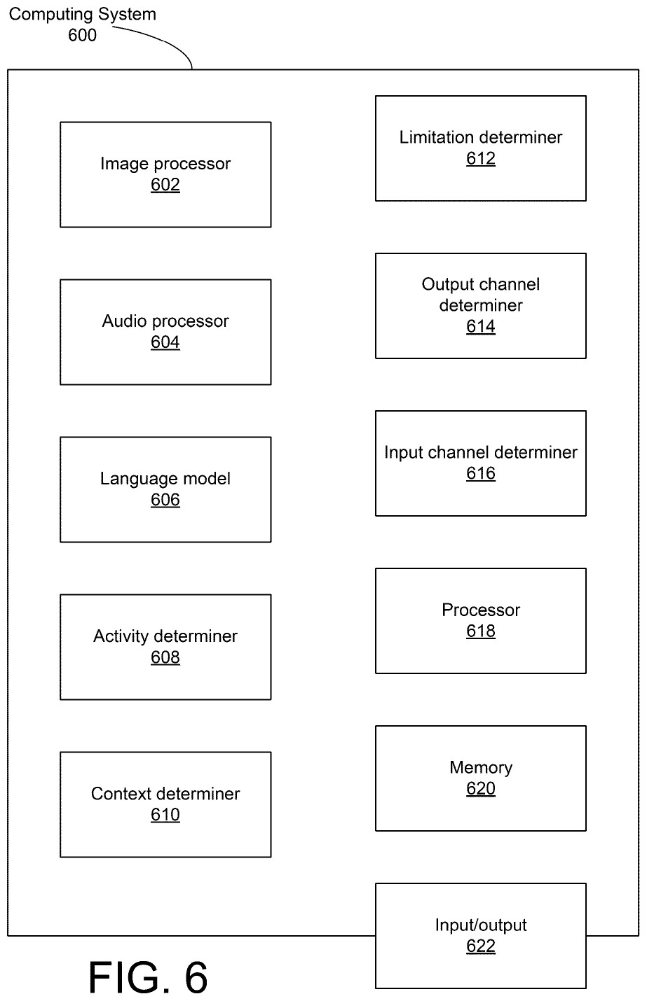

FIG. 6 is a block diagram of a computing system 600. The computing system 600 can be an example of, and/or implement features and/or functionalities of, the head-mounted device 154 and/or egocentric device 302. In some examples, the computing system 600 is in communication with, and performs operations based on images and/or audio captured by, the head-mounted device 154 and/or egocentric device 302. In some examples, the computing system 600 implements functions and/or methods performed by the head-mounted device 154 and/or egocentric device 302 in combination with a computing system in communication with the head-mounted device 154 and/or egocentric device 302.

The computing system 600 can include an image processor 602. The image processor 602 can process images captured by one or more cameras included in and/or in communication with the computing system 600 to classify and/or identify objects in a scene and/or describe the scene. The images can be considered visual input received from a camera included in the computing system 600. The camera can capture images from a direction away from the user, so that the images are images similar to the perspective of the user, or an “egocentric” perspective. Examples of images processed by the image processor 602 include the images 202, 204, 206, 208, 210, 212, 214, 216.

The computing system 600 can include an audio processor 604. The audio processor 604 can process audio signals captured by one or more microphones included in and/or in communication with the computing system 600 to describe the scene. The audio processor 604 can classify a type of noise and/or determine a volume of noise (such as in decibels).

The computing system 600 can include a language model 606. The language model 606 can include a large language model. The language model 606 can describe a scene, such as the scene 102, in words and/or text. In some examples, the language model 606 implements bootstrapping language-image pre-training with frozen image encoders and large language models (BLIP-2) model in combination with a generative pre-trained transformer 3 (GPT-3) model to describe the scene. The language model 606 can generate, based on the visual input processed by the image processor 602, text describing an activity of the user. The language model 606 can describe the scene based on objects identified by the image processor 602, the classification of noise determined by the audio processor 604, and/or the volume of noise determined by the audio processor 604. The description can include, for example, an identification of an object being held by the user 152, a caption describing the scene, a caption describing an activity of a hand of the user 152, a description of an activity of the user 152, and/or a description of the environment.

The computing system 600 can include an activity determiner 608. The activity determiner 608 can determine an activity of the user. In some examples, the activity determiner 608 can determine the activity of the user based on the textual description of the scene generated by the language model 606. In some examples, the activity determiner 608 can determine the activity of the user based on the processing of the image by the image processor 602 and/or the processing of the audio data by the audio processor 604. The determined activity can include, for example, cooking or washing dishes, playing tennis, or playing a video game.

The computing system 600 can include a context determiner 610. The context determiner 610 can determine a context and/or environment of the user. In some examples, the context determiner 610 can determine the context and/or environment of the user based on the textual description of the scene generated by the language model 606. In some examples, the context determiner 610 can determine the context and/or environment of the user based on the processing of the image by the image processor 602 and/or the processing of the audio data by the audio processor 604. The context and/or environment of the user can include, for example, a kitchen, a concert, or a public bus.

The computing system 600 can include a limitation determiner 612. The limitation determiner 612 can determine limitations of communication channels. In some examples, the limitation determiner 612 can determine the limitations based on text generated by the language model 606. In some examples, the limitation determiner 612 can determine limitations of communication channels based on the activity determined by the activity determiner 608 and/or the context determined by the context determiner 610. In some examples, the limitation determiner 612 determines a limitation of the user based on activity of the user. In some examples, the limitation determiner 612 determines a limitation of the user based on a context and/or environment of the user. In some examples, the limitation determiner 612 determines a limitation of the user based on visual input processed by the image processor 602 and/or audio input processed by the audio processor 604. The limitation determiner 612 can determine limitations of, for example, vision and/or eyes, hearing, vocal system, and/or hands and/or fingers. In some examples, the limitation determiner 612 can determine the limitations of communications with respect to physical parts of the user as described with respect to FIG. 5. In some examples, the limitation determiner 612 can determine availability as available, slightly affected, affected, or unavailable.

In some examples, the limitation determiner 612 applies a non-binary scale with more than two possibilities (rather than only available or unavailable), such as a four-level scale, for measuring channel availability. In some examples, the four levels, in order of decreasing availability and/or increasing limitation, are available, slightly affected, affected, and unavailable. The scale with more than two possibilities enables the computing system 600 to select the best channel for communication (e.g. selecting a slightly affected channel rather than an affected channel).

A channel can be considered available if the channel is not currently involved in any activity or constrained by any environmental factors; little to no effort may be needed to communicate via an available channel. An example of available channels is a user sitting at a desk with hands-free, not engaged in any task, and no background noise interfering with hearing or speech. A channel can be considered slightly affected if the channel is engaged in an activity or constrained by an environmental factor; given a new task that requires a slightly affected channel, users can multitask, easily pause and resume to the current activity, or easily overcome the situation. An example of a slightly affected tactile input channel is a user holding a remote control, which the user can quickly put down to free up a hand for another task. A channel can be considered affected if the channel is involved in an activity or constrained by an environmental factor; given a new task, the user may experience inconvenience or require some effort to use an affected channel. An example of an affected channel that requires use of hands is a user carrying grocery bags in both hands, making use of the hands for other tasks challenging without putting the bags down first. A channel can be considered unavailable due to an activity or environmental factor that prevents the user from using the channel for a new task without substantial changes, significant adaptation, or changing the environment. An example of an unavailable channel is audio input or output when a user is attending a loud concert, making hearing incoming notifications or carrying on a conversation without stepping outside impossible. The distinctions between levels of availability can be based on an amount of effort for a user to free up a channel for an interactive task and reoccupy the channel later.

The computing system 600 can include an output channel determiner 614. The output channel determiner 614 can determine an output channel via which to send information and/or notifications to the user. The output channel determiner 614 can determine the output channel based on the limitation(s) determined by the limitation determiner 612. The output channel determiner 614 can determine an output communication channel that is most available and/or least limited. The output channel determiner 614 can determine that the output should be graphical output via a display, audio output via a speaker, or haptic feedback, as non-limiting examples.

The computing system 600 can include an input channel determiner 616. The input channel determiner 616 can determine an input channel via which to receive information from the user. The input channel determiner 616 can determine the input channel based on the limitation(s) determined by the limitation determiner 612. The input channel determiner 616 can determine an input communication channel that is most available and/or least limited. The input channel determiner 616 can determine that the input should be gaze input, voice input, or touch input, as non-limiting examples.

The computing system 600 can include at least one processor 618. The at least one processor 618 can execute instructions, such as instructions stored in at least one memory device 620, to cause the computing system 600 to perform any combination of methods, functions, and/or techniques described herein.

The computing system 600 can include at least one memory device 620. The at least one memory device 620 can include a non-transitory computer-readable storage medium. The at least one memory device 620 can store data and instructions thereon that, when executed by at least one processor, such as the processor 618, are configured to cause the computing system 600 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 600 can be configured to perform, alone, or in combination with another computing device such as or a server in communication with the computing system 600, any combination of methods, functions, and/or techniques described herein.

The computing system 600 may include at least one input/output node 622. The at least one input/output node 622 may receive and/or send data, such as from and/or to, another computer, and/or may receive input and provide output from and to a user such as the user 152. The input and output functions may be combined into a single node, or may be divided into separate input and output nodes. The input/output node 622 can include, for example, a microphone, a camera, an inertial measurement unit (IMU), a display, a speaker, a microphone, one or more buttons, and/or one or more wired or wireless interfaces for communicating with other computing devices.

FIGS. 7A, 7B, and 7C show an example of a head-mounted device 700. The head-mounted device 700 can be an example of the head-mounted device 154, egocentric device 302, and/or computing system 600. As shown in FIGS. 7A, 7B, and 7C, the example head-mounted device 700 includes a frame 702. The frame 702 includes a front frame portion defined by rim portions 703A, 703B surrounding respective optical portions in the form of lenses 707A, 707B, with a bridge portion 709 connecting the rim portions 703A, 703B. Arm portions 705A, 705B are coupled, for example, pivotably or rotatably coupled, to the front frame by hinge portions 710A, 710B at the respective rim portion 703A, 703B. In some examples, the lenses 707A, 707B may be corrective/prescription lenses. In some examples, the lenses 707A, 707B may be an optical material including glass and/or plastic portions that do not necessarily incorporate corrective/prescription parameters. Displays 712A, 712B may be coupled in a portion of the frame 702. In the example shown in FIG. 7B, the displays 712A, 712B are coupled in the arm portions 705A, 705B and/or rim portions 703A, 703B of the frame 702. In some examples, the head-mounted device 700 can also include an audio output device 716 (such as, for example, one or more speakers), an illumination device 718, at least one processor 711, an outward-facing image sensor 714 (or camera), and gaze-tracking cameras 719A, 719B that can capture images of eyes of the user to track a gaze of the user. In some examples, the head-mounted device 700 may include a see-through near-eye display. The processor 711 (which can be an example of the processor 618) can include a non-transitory computer-readable storage medium comprising instructions thereon that, when executed by the at least one processor 711, cause the head-mounted device 700 to perform any combination of methods, functions, and/or techniques described herein. For example, the displays 712A, 712B may be configured to project light from a display source onto a portion of teleprompter glass functioning as a beamsplitter seated at an angle (e.g., 30-45 degrees). The beamsplitter may allow for reflection and transmission values that allow the light from the display source to be partially reflected while the remaining light is transmitted through. Such an optic design may allow a user to see both physical items in the world, for example, through the lenses 707A, 707B, next to content (for example, digital images, user interface elements, virtual content, and the like) generated by the displays 712A, 712B. In some implementations, waveguide optics may be used to depict content on the displays 712A, 712B via outcoupled light 720A, 720B. The images projected by the displays 712A, 712B onto the lenses 707A, 707B may be translucent, allowing the user to see the images projected by the displays 712A, 712B as well as physical objects beyond the head-mounted device 700.

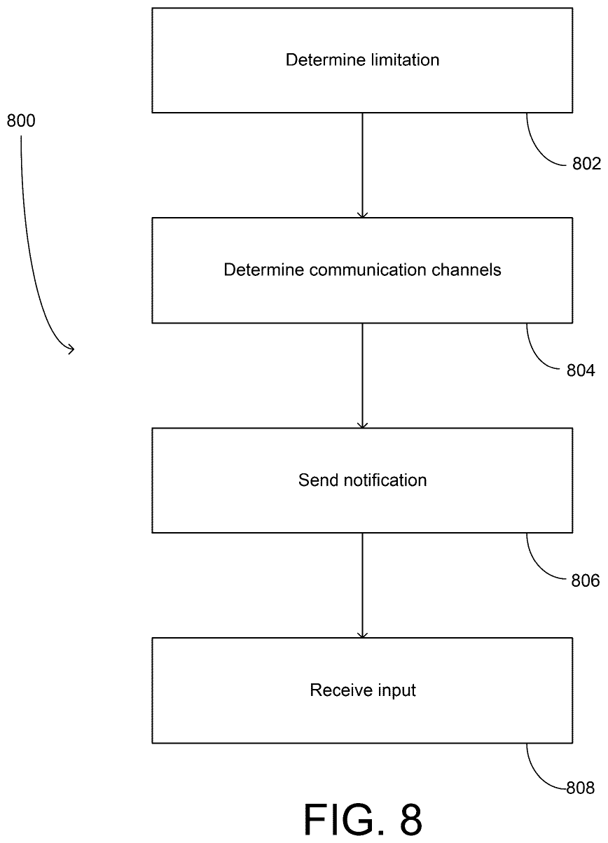

FIG. 8 is a flowchart showing a method 800 performed by a computing system. The method 800 can be performed by the head-mounted device 154, the egocentric device 302, the computing system 600, and/or the head-mounted device 700.

The method 800 can include determining, by a head-mounted device, a limitation of a user based on a visual input received from a camera included in the head-mounted device (802). The method 800 can include determining an output communication channel and an input communication channel based on the limitation of the user (804). The method 800 can include sending a notification to the user via the output communication channel (806). The method 800 can include receiving an input from the user via the input communication channel (808).

According to an example, the camera captures images from a direction away from the user.

According to an example, determining the limitation of the user includes generating text based on the visual input, the text describing an activity of the user; and determining the limitation of the user based on the text.

According to an example, determining the limitation of the user includes generating text based on the visual input, the text describing an activity of the user; and determining the limitation of the user based on the activity of the user.

According to an example, determining the limitation of the user includes inputting the visual input into a model, the visual input showing the user focusing on an object outside the head-mounted device; processing the visual input by the model; and outputting, by the model, a description indicating a visual limitation of the user.

According to an example, the limitation of the user includes determining, by a microphone included in the head-mounted device, a volume of noise; determining that the volume of noise satisfies a noise threshold; and based on the volume of noise satisfying the noise threshold, determining that the noise interferes with audio output.

According to an example, determining the limitation of the user includes determining, by a microphone included in the head-mounted device, a volume of noise; determining that the volume of noise satisfies a noise threshold; and determining that the noise interferes with voice input.

According to an example, the limitation of the user includes inputting the visual input into a model, the visual input showing the user performing an activity with a hand of the user; processing the visual input by the model; and outputting, by the model, a description indicating a limitation of the hand of the user.

According to an example, determining the limitation of the user includes determining the limitation of the user based on the visual input received from the camera included in the head-mounted device and an audio input received from a microphone included in the head-mounted device.

According to an example, determining the limitation of the user is based on determining an activity of a body part of the user based on the visual input.

According to an example, determining the limitation of the user is based on an environment of the user, the environment of the user being determined based on the visual input and audio input received by a microphone included in the head-mounted device.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A method comprising:
determining, by a head-mounted device, a limitation of a user based on a visual input received from a camera included in the head-mounted device;
determining an output communication channel and an input communication channel based on the limitation of the user;
sending a notification to the user via the output communication channel; and
receiving an input from the user via the input communication channel.

2. The method of claim 1, wherein the camera captures images from a direction away from the user.

3. The method of claim 1, wherein determining the limitation of the user includes:
generating text based on the visual input, the text describing an activity of the user; and
determining the limitation of the user based on the text.

4. The method of claim 1, wherein determining the limitation of the user includes:
generating text based on the visual input, the text describing an activity of the user; and
determining the limitation of the user based on the activity of the user.

5. The method of claim 1, wherein determining the limitation of the user includes:
inputting the visual input into a model, the visual input showing the user focusing on an object outside the head-mounted device;
processing the visual input by the model; and
outputting, by the model, a description indicating a visual limitation of the user.

6. The method of claim 1, wherein the limitation of the user includes:
determining, by a microphone included in the head-mounted device, a volume of noise;
determining that the volume of noise satisfies a noise threshold; and
based on the volume of noise satisfying the noise threshold, determining that the noise interferes with audio output.

7. The method of claim 1, wherein determining the limitation of the user includes:
determining, by a microphone included in the head-mounted device, a volume of noise;
determining that the volume of noise satisfies a noise threshold; and
determining that the noise interferes with voice input.

8. The method of claim 1, wherein the limitation of the user includes:
inputting the visual input into a model, the visual input showing the user performing an activity with a hand of the user;
processing the visual input by the model; and
outputting, by the model, a description indicating a limitation of the hand of the user.

9. The method of claim 1, wherein determining the limitation of the user includes determining the limitation of the user based on:
the visual input received from the camera included in the head-mounted device; and
an audio input received from a microphone included in the head-mounted device.

10. The method of claim 1, wherein determining the limitation of the user is based on determining an activity of a body part of the user based on the visual input.

11. The method of claim 1, wherein determining the limitation of the user is based on an environment of the user, the environment of the user being determined based on the visual input and audio input received by a microphone included in the head-mounted device.

12. A non-transitory computer-readable storage medium comprising instructions stored thereon that, when executed by at least one processor, are configured to cause a computing system to:
determine a limitation of a user based on a visual input received from a camera included in a head-mounted device;
determine an output communication channel and an input communication channel based on the limitation of the user;
send a notification to the user via the output communication channel; and
receive an input from the user via the input communication channel.

13. The non-transitory computer-readable storage medium of claim 12, wherein the camera captures images from a direction away from the user.

14. The non-transitory computer-readable storage medium of claim 12, wherein determining the limitation of the user includes:
generating text based on the visual input, the text describing an activity of the user; and
determining the limitation of the user based on the text.

15. The non-transitory computer-readable storage medium of claim 12, wherein determining the limitation of the user includes:
generating text based on the visual input, the text describing an activity of the user; and
determining the limitation of the user based on the activity of the user.

16. The non-transitory computer-readable storage medium of claim 12, wherein determining the limitation of the user includes determining the limitation of the user based on:
the visual input received from the camera included in the head-mounted device; and
an audio input received from a microphone included in the head-mounted device.

17. A computing system comprising:
at least one processor; and
a non-transitory computer-readable storage medium comprising instructions stored thereon that, when executed by the at least one processor, are configured to cause the computing system to:
determine a limitation of a user based on a visual input received from a camera included in a head-mounted device;
determine an output communication channel and an input communication channel based on the limitation of the user;
send a notification to the user via the output communication channel; and
receive an input from the user via the input communication channel.

18. The computing system of claim 17, wherein the camera captures images from a direction away from the user.

19. The computing system of claim 17, wherein determining the limitation of the user includes:
generating text based on the visual input, the text describing an activity of the user; and
determining the limitation of the user based on the text.

20. The computing system of claim 17, wherein determining the limitation of the user includes:
generating text based on the visual input, the text describing an activity of the user; and
determining the limitation of the user based on the activity of the user.
